(19) United States
(12) Patent Application Publication
(10) Pub. No.: US 2011/0218841 A1
(43) Pub. Date: Sep. 8, 2011

(54) BACK OFFICE PROCESS MONITORING AND ANALYSIS

(75) Inventors: Om D. Deshmukh, New Delhi (IN); Chitra Dorai, Hawthorne, NY (US); Shailesh Joshi, New Milford, CT (US); Maureen E. Rzasa, Phoenix, AZ (US); Karthik Visweswariah, Bangalore (IN); Gary J. Wright, Henderson, NV (US); Sai Zeng, Elmsford, NY (US)

(73) Assignee: INTERNATIONAL BUSINESS MACHINES CORPORATION, Armonk, NY (US)

(21) Appl. No.: 12/718,335

(22) Filed: Mar. 5, 2010

(51) Int. Cl. G06Q 10/00; G06F 17/30

(52) U.S. Cl. 705/7.39; 707/802; 707/E17.044

(57) ABSTRACT

According to one illustrative embodiment, a method is provided for monitoring and analyzing an office process. Information relating to desktop interaction activities of an agent and non-desktop activities of the agent are collected to form collected information. The collected information is inferred to derive delimiters relating to the desktop interaction activities and the non-desktop activities of the agent, at least one transaction performed by the agent, at least one application used by the agent, and the office process. Metrics and key performance indicators relating to a behavior of the agent, a behavior of the at least one transaction, a behavior of the at least one application and a behavior of an office process are computed to form computed information, and the collected information and the computed information are stored into a data store.

### BACKGROUND

1. Field

The disclosure relates generally to a computer implemented method, a data processing system, and a computer readable storage medium having a computer program product encoded thereon. More specifically, this disclosure relates to a computer implemented method, a data processing system, and a computer readable storage medium having a computer program product encoded thereon for monitoring and analyzing an office process.

2. Description of the Related Art

Contact study is often a part of CRM (Customer Relations Management) activities to assist an enterprise in improving or transforming its business processes. For example, a contact study may be used to assess operations in a company's front office, such as call center operations, and in the company's back office, such as case management operations. As an outcome of a contact study, an enterprise is often able to identify key areas for improvement, including providing data for business case justification to support an overall business vision, to initiate any transformation of processes and operations, and to leverage optimized business processes as a competitive differentiator.

In a back office, a contact study includes monitoring “desktop interaction” activities performed by an agent to help identify process steps performed by the agent, and how the agent uses his/her desktop to perform assigned activities, as well as separating “non-desktop” activities performed by the agent. An agent's desktop interaction activities may be monitored by a human observer, either by sitting beside the agent and manually recording data, or by recording an agent's screens remotely and replaying and reviewing the remotely collected data. Current monitoring tools used for monitoring an agent's desktop interaction activities may include web logging tools, application logging tools, screen capture tools, screen recording tools and the like.

An agent's non-desktop activities may be monitored and recorded by a human observer or by a self-reporting tool by which the agent logs the beginning and end of each non-desktop activity that he/she performs.

After all the data relating to the agent's activities have been collected, the data is consolidated and analysts use the consolidated data to perform an analysis with respect to the agent's overall performance and the processes performed by the agent.

Current contact study procedures are intrusive and expensive (it has been shown that an average contact study requires about 330 resource hours per engagement). In addition, current contact studies are not scalable and have a low account penetration. Also, current self-reporting procedures may require several activity logs each day, provide no deep visibility into the logged activities, and contribute to agent overhead and impact their utilization. Yet further, self-reporting procedures provide no guarantee of the accuracy of the logged information.

### SUMMARY

According to one illustrative embodiment of the present disclosure, a method for monitoring and analyzing an office process is provided. Information relating to desktop interaction activities of an agent and non-desktop activities of the agent are collected to form collected information. The collected information is inferred to derive delimiters relating to the desktop interaction activities and the non-desktop activities of the agent, at least one transaction performed by the agent, at least one application used by the agent, and the office process. Metrics and key performance indicators relating to a behavior of the agent, a behavior of the at least one transaction, a behavior of the at least one application and a behavior of an office process are computed to form computed information, and the collected information and the computed information are stored into a data store.

### BRIEF DESCRIPTION OF THE SEVERAL VIEWS OF THE DRAWINGS

FIG. 1 depicts a pictorial representation of a network of data processing systems in which illustrative embodiments may be implemented;

FIG. 2 is an illustration of a block diagram of a data processing system in accordance with an illustrative embodiment;

FIG. 3 is an illustration of a diagram that schematically depicts a system for monitoring and analyzing a back office process in accordance with an illustrative embodiment;

FIG. 4 is an illustration of a flowchart that depicts an exemplary back office process being monitored in accordance with an illustrative embodiment;

FIG. 5 is an illustration of a flowchart that depicts a process for monitoring and analyzing a back office process in accordance with an illustrative embodiment;

FIG. 6 is an illustration of a flowchart that depicts a process for planning and customizing a monitoring operation in accordance with an illustrative embodiment;

FIG. 7 is an illustration of a flowchart that depicts a process for collecting information relating to an agent's desktop interaction activities in accordance with an illustrative embodiment;

FIG. 8 is an illustration of a flowchart that depicts a process for collecting information relating to an agent's non-desktop activities in accordance with an illustrative embodiment;

FIG. 9 is an illustration of a flowchart that depicts a process for inferring events to derive delimiters of agent activities in accordance with an illustrative embodiment;

FIG. 10 is an illustration of a flowchart that depicts a process for inferring events to derive delimiters of transaction activities in accordance with an illustrative embodiment;

FIG. 11 is an illustration of a flowchart that depicts a process for inferring events to derive delimiters of process activities in accordance with an illustrative embodiment;

FIG. 12 is an illustration of a flowchart that depicts a process for inferring events to derive delimiters of system interactions in accordance with an illustrative embodiment;

FIG. 13 is an illustration of a flowchart that depicts a process for computing metrics and KPIs (Key Performance Indicators) relating to agent/system/transaction/process behaviors in accordance with an illustrative embodiment;

FIG. 14 is an illustration listing types of process behavior analyses that may be performed in accordance with an illustrative embodiment;

FIG. 15 is an illustration listing types of agent behavior analyses that may be performed in accordance with an illustrative embodiment;

FIG. 16 is an illustration listing types of transaction behavior analyses that may be performed in accordance with an illustrative embodiment;

FIG. 17 is an illustration listing types of system behavior analyses that may be conducted in accordance with an illustrative embodiment; and

FIG. 18 is an illustration that depicts a flowchart of a process for integrating agent/system/transaction/process behavior analyses in accordance with an illustrative embodiment.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

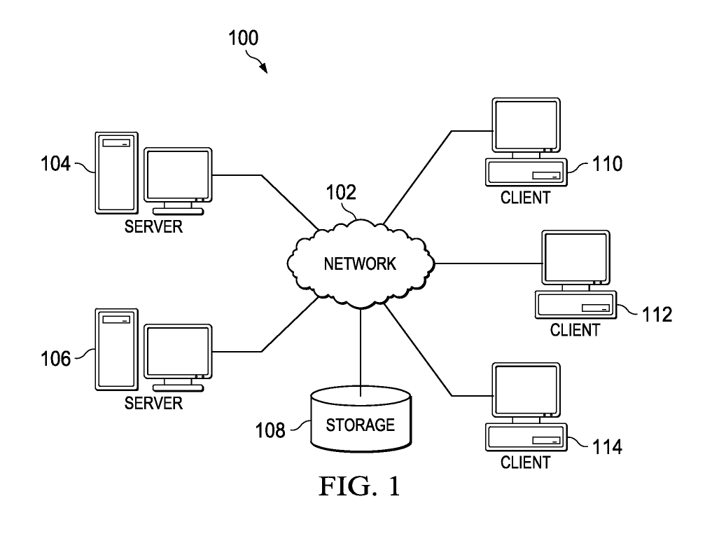

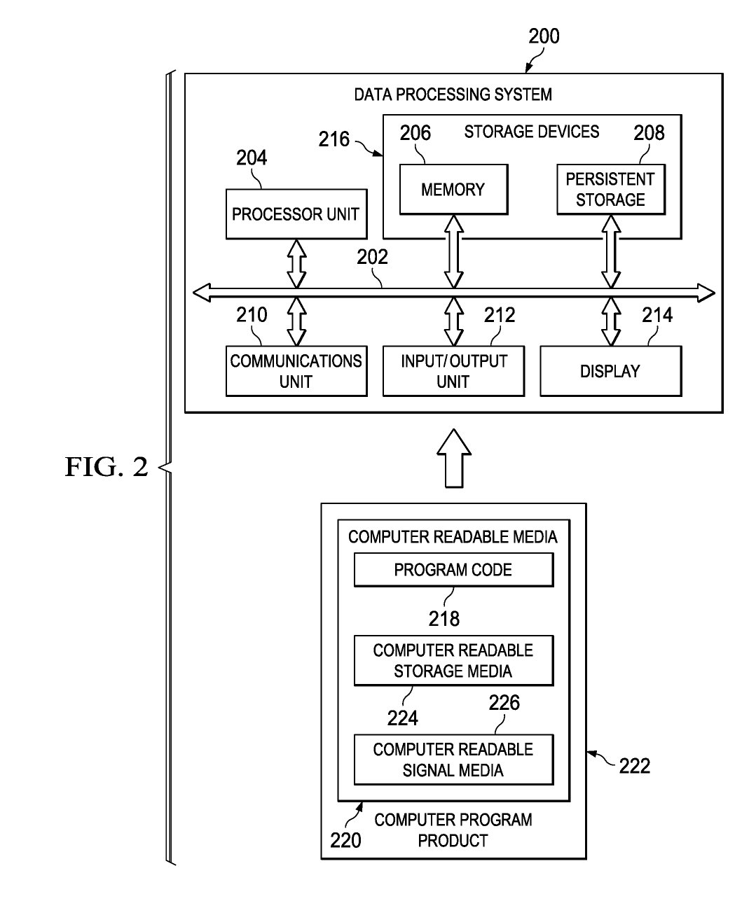

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides information, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 depicts a diagram of a data processing system in accordance with an illustrative embodiment. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Memory 206, in these examples, may be, for example, a random access memory, or any other suitable volatile or non-volatile storage device. Persistent storage 208 may take various forms, depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Communications unit 210, in these examples, provides for communication with other data processing systems or devices. In these examples, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 for execution by processor unit 204. The processes of the different embodiments may be performed by processor unit 204 using computer implemented instructions, which may be located in a memory, such as memory 206.

These instructions are referred to as program code, computer usable program code, or computer readable program code that may be read and executed by a processor in processor unit 204. The program code, in the different embodiments, may be embodied on different physical or computer readable storage media, such as memory 206 or persistent storage 208.

Program code 218 is located in a functional form on computer readable media 220 that is selectively removable and may be loaded onto or transferred to data processing system 200 for execution by processor unit 204. Program code 218 and computer readable media 220 form computer program product 222. In one example, computer readable media 220 may be computer readable storage media 224 or computer readable signal media 226. Computer readable storage media 224 may include, for example, an optical or magnetic disc that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory that is connected to data processing system 200. In some instances, computer readable storage media 224 may not be removable from data processing system 200.

Alternatively, program code 218 may be transferred to data processing system 200 using computer readable signal media 226. Computer readable signal media 226 may be, for example, a propagated data signal containing program code 218. For example, computer readable signal media 226 may be an electro-magnetic signal, an optical signal, and/or any other suitable type of signal. These signals may be transmitted over communications links, such as wireless communications links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communications links or wireless transmissions containing the program code.

In some illustrative embodiments, program code 218 may be downloaded over a network to persistent storage 208 from another device or data processing system through computer readable signal media 226 for use within data processing system 200. For instance, program code stored in a computer readable storage media in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Illustrative embodiments provide a computer implemented method, a data processing system, and a computer readable storage medium having a computer program product encoded thereon for monitoring and analyzing an office process, for example, a back office process of an enterprise, in order to generate insight to identify process improvement opportunities. Back office processes of an enterprise may include, for example, behavior of an agent, transaction behavior, process behavior and system behavior.

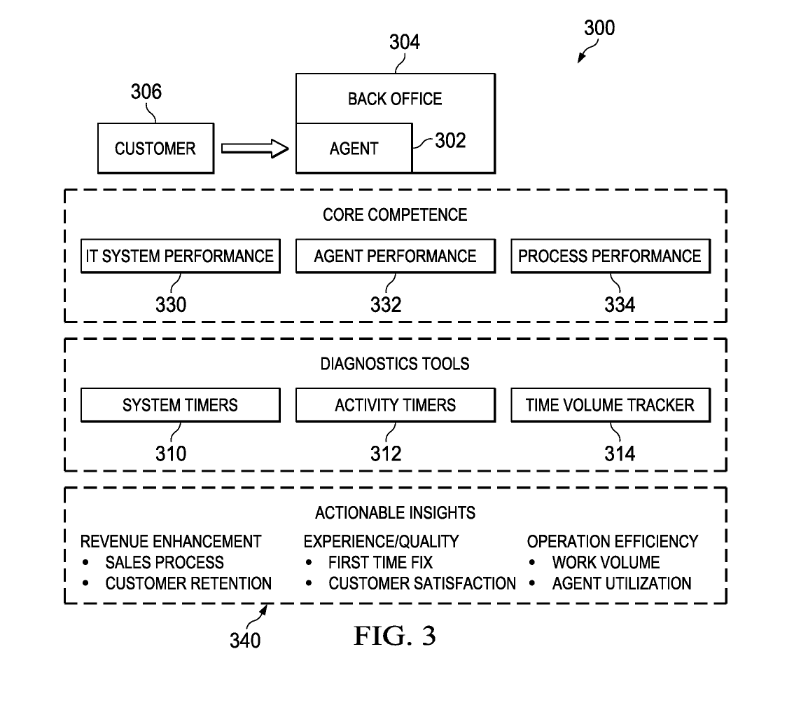

FIG. 3 is an illustration of a diagram that schematically depicts a system for monitoring and analyzing a back office process in accordance with an illustrative embodiment. The system is generally designated by reference number 300, and utilizes a combination of system timers 310, activity timers 312 and Time Volume Tracker 314 to collect information regarding a back office process, for example, a process conducted by an agent 302 working in a back office 304 of an enterprise to complete a transaction for a customer 306.

The system timers 310 provide a capability for automatic capture and tracking of agent desktop activities. A system timer automatically detects when the agent switches computer applications, how much time he/she spends on a particular application, and computes related metrics. The activity timers 312 provide capabilities to automatically detect the delimiters of a process activity an agent conducted, and determine the duration of the activity. An activity timer also tracks end-to-end activities for a transaction. Time Volume Tracker 314 is used to track the volume of transactions for a process activity. The Time Volume Tracker 314 allows an agent to manually log his/her activities.

The information collected is used to assess IT system performance 330, back office agent performance 332, and overall process level performance 334. The assessment mainly tries to provide actionable insights 340 to, for example, enhance revenue, improve the overall agent/customer experience, and increase operation efficiency. For example, the assessment may answer questions such as: (a) Are there steps in a process that are unnecessary or redundant and, hence, increase the transaction Average Handling Time (AHT)? (b) Can any of the steps of the process be modified to either improve customer satisfaction or to reduce the AHT or both? (c) Is the amount of time spent in each activity of the transaction (diagnose/processing/payment/and so on) appropriate? (d) Is there a seamless and healthy communication across various client-side systems and applications and the agent's desktop? (e) What is the optimal time to contact a customer to explore cross-sell/up-sell opportunities? (f) What are the optimal strengths of the process that can be replicated in other processes?

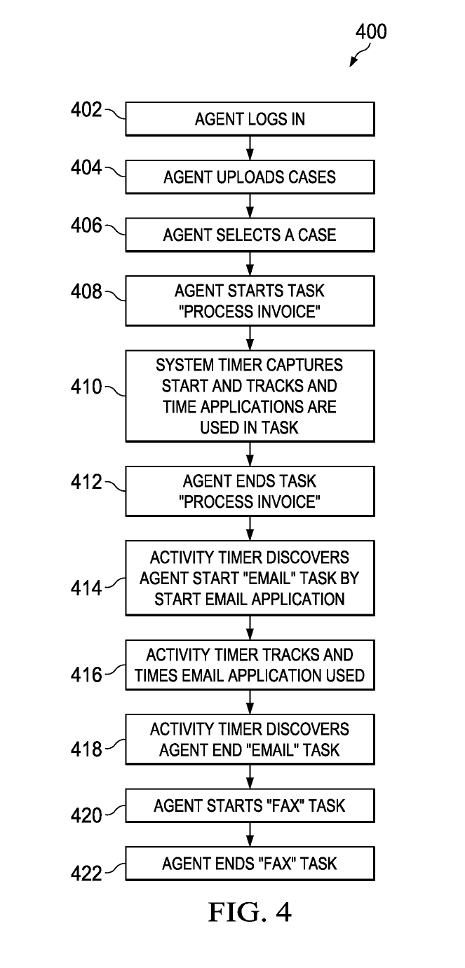

FIG. 4 is an illustration of a flowchart that depicts an exemplary back office process being monitored in accordance with an illustrative embodiment. The back office process is generally designated by reference number 400, and may be monitored using system and activity timers, Time Volume Tracker techniques and self-reporting. The process may begin when an agent logs in (Step 402). After logging in, the agent may upload cases (Step 404), and then select a case to work on (Step 406).

The agent then starts the task of processing an invoice in connection with the selected case (Step 408). A system timer captures the start and tracks the times that applications are used in the task (Step 410). The agent then ends the task of processing the invoice (Step 412). By integrating the use of a system timer with Time Volume Tracker techniques, illustrative embodiments enable slicing and dicing the time spent by the agent in performing a task into a timeline of various applications used in the task. It also allows for various aspects of a task such as processing an invoice to be separately monitored and recorded

The agent may then start an email task. An activity timer discovers the start of the email task by the agent starting the email application (Step 414). The activity timer then tracks and times the email application that is used (Step 416), and discovers when the agent ends the email task (Step 418). The activity timer permits an agent activity such as sending an email to be automatically monitored as opposed to requiring use of a self reporting tool.

The agent may then decide to start a faxing task (Step 420), and thereafter end the faxing task (Step 422). The beginning and end of this task may be manually logged by an agent using Time Volume Tracker techniques.

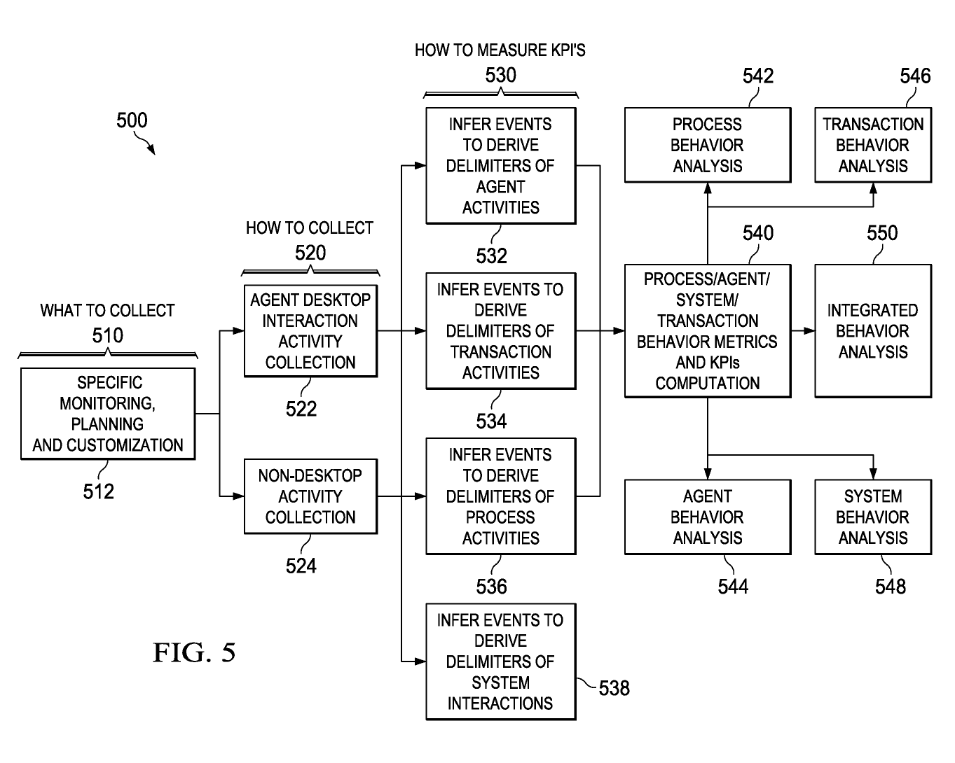

FIG. 5 is an illustration of a flowchart that depicts a process for monitoring and analyzing a back office process in accordance with an illustrative embodiment. The process is generally designated by reference number 500, and includes steps for determining what information to collect (generally designated as Step 510); determining how to collect the information (generally designated by reference number 520); determining the measurements (generally designated by Step 530); computing metrics and KPIs with respect to process/agent/system/transaction behaviors (Step 540); analyzing the process behavior (Step 542), the agent behavior (Step 544), the transaction behavior (Step 546) and the system behavior (Step 548); and integrating the behavior analyses (Step 550).

Determining what information to collect 510 requires planning and customizing the monitoring to meet the specific requirements of a customer or other enterprise (Step 512). The term “enterprise” as used herein may be a company, a university, a governmental agency or any other entity that performs an activity to be monitored.

Determining how to collect the information 520 includes determining how to collect information relating to an agent's desktop interaction activities (Step 522) and determining how to collect the agent's non-desktop activities (Step 524). As used herein, an “agent” may be any individual, such an employee or a contractor of an enterprise.

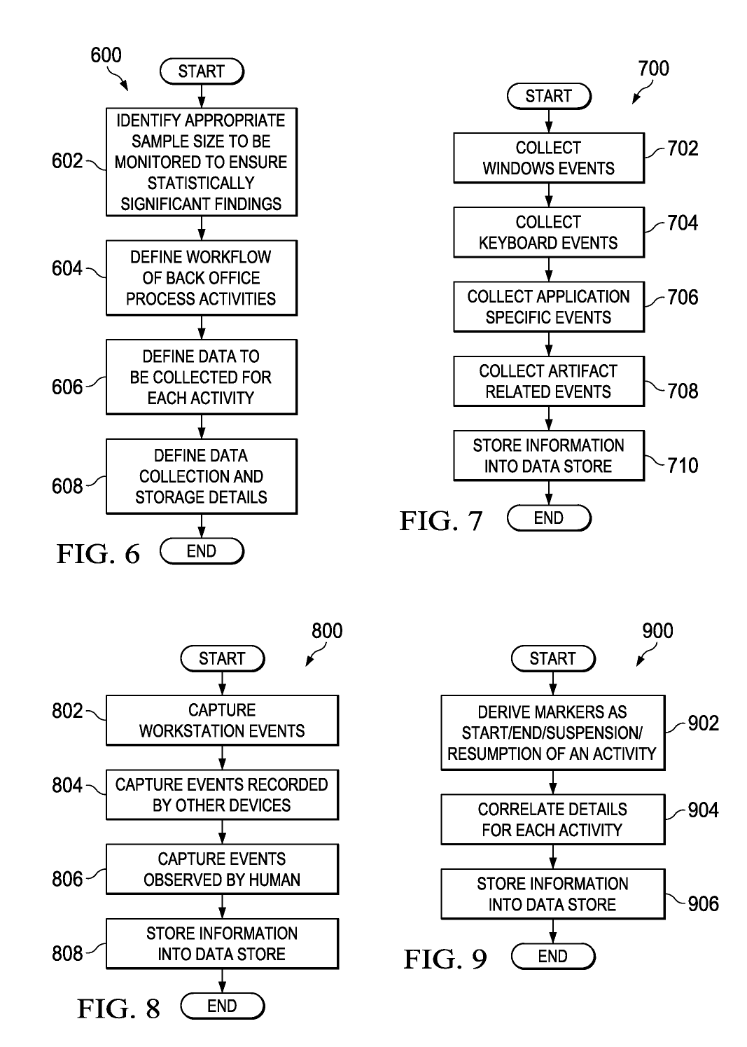

Determining the measurements 530 includes inferring events to derive delimiters of agent activities (Step 532), inferring events to derive delimiters of transaction activities (Step 534), inferring events to derive delimiters of process activities (Step 536) and inferring events to derive delimiters of system interactions (Step 538). Steps described with reference to FIG. 5 are described in greater detail hereinafter with reference to FIGS. 6-18.

FIG. 6 is an illustration of a flowchart that depicts a process for planning and customizing a monitoring operation in accordance with an illustrative embodiment. The process illustrated in FIG. 6 is generally designated by reference number 600, and may be implemented as Step 512 in FIG. 5.

Process 600 may begin by identifying an appropriate sample size to be monitored to ensure statistically significant findings (Step 602). The process may also include defining the workflow of back office process activities (Step 604), defining the data to be collected for each process activity (Step 606), and defining data collection and data storage details (Step 608).

Defining the data to be collected 606 may include identifying indicators of the beginning and end of each activity, defining related desktop applications that assist in performing each activity, identifying details (or input/output/intermediate artifacts) to be captured for each activity (e.g., keyboard/mouse input, references to digital documents of printing activities), and identifying the means for collecting information of indicators and details (e.g., desktop events capture, video/audio/human input).

Defining data collection and storage details 608 may include, for example, defining frequency of storage or locations of storage.

FIG. 7 is an illustration of a flowchart that depicts a process for collecting information relating to an agent's desktop interaction activities in accordance with an illustrative embodiment. The process illustrated in FIG. 7 is generally designated by reference number 700, and may be implemented as Step 522 in FIG. 5. The process may include collecting window events (Step 702). Examples of window events that may be collected include: open, close and switch windows. Keyboard events may also be collected (Step 704), for example, key-in events and mouse events. Other events that may be collected include application specific events such as app page display, page switch, url activate, switch, close, and http request/response events (Step 706), and artifact related events such as create, edit, save, and close (Step 708). The collected agent's desktop interaction activities may then be stored into a data store (Step 710).

FIG. 8 is an illustration of a flowchart that depicts a process for collecting information relating to an agent's non-desktop activities in accordance with an illustrative embodiment. The process is generally designated by reference number 800, and may be implemented as Step 524 in FIG. 5. Non-desktop activities that may be monitored include workstation events, for example, events explicitly triggered by a program and/or a human (Step 802); events recorded by other devices, for example, a camera recording that an agent walks away from his/her desk (Step 804); and events observed by a human observer (Step 806). The collected information regarding the agent's non-desktop activities is stored into a data store (Step 808).

FIG. 9 is an illustration of a flowchart that depicts a process for inferring events to derive delimiters of agent activities in accordance with an illustrative embodiment. The process is generally designated by reference number 900, and may be implemented as Step 532 in FIG. 5. The process includes deriving markers as a start or an end of an activity or as a suspension or a resumption of an activity (Step 902). This may be done by detecting events that signal the start/end/suspension/resumption of the activity, detecting a signature event pattern belonging to the activity, and learning through identified pre-activities and post-activities. Possible types of markers may include system events such as activation/open/close of windows, application specific events such as page display and page switch, and observed events such as human observation of the beginning/end/suspension/resumption of an activity. The details (including input/output/intermediate artifacts) for each activity are then correlated for each activity (Step 904), for example, agent information, keyboard/mouse input, windows events, and references to digital documents; and the correlated information is stored into a data store, Step 906).

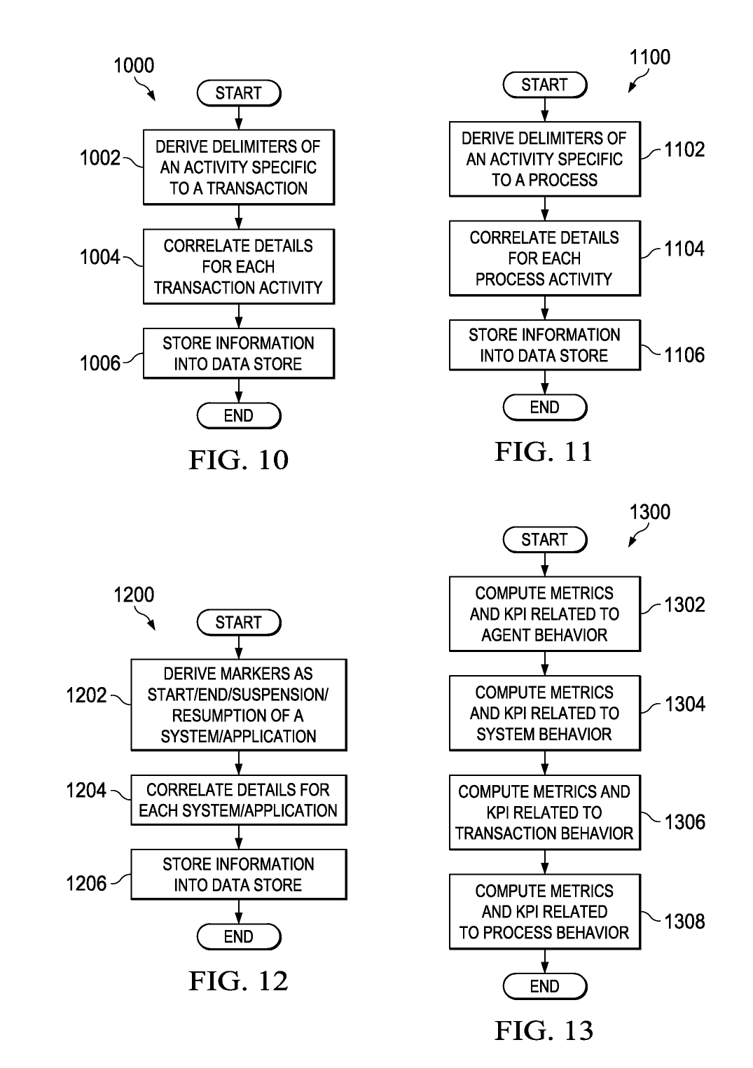

FIG. 10 is an illustration of a flowchart that depicts a process for inferring events to derive delimiters of transaction activities in accordance with an illustrative embodiment. The process is generally designated by reference number 1000, and may be implemented as Step 534 in FIG. 5. The process begins by deriving delimiters of an activity that are specific to a transaction (Step 1002). This may be done by detecting delimiters of activities belonging to a single transaction or to a group of transactions. The details (including input/output/intermediate artifacts) are then correlated for each transaction activity (Step 1004), for example, by transaction ID, agent input, references to digital documents related to the transactions, etc. The correlated information is then stored into a data store (Step 1006).

FIG. 11 is an illustration of a flowchart that depicts a process for inferring events to derive delimiters of process activities in accordance with an illustrative embodiment. The process is generally designated by reference number 1100, and may be implemented as Step 536 in FIG. 5. The process begins by deriving delimiters of an activity specific to a process (Step 1102). This may be done by detecting delimiters of activities belonging to the process. Details (including input/output/intermediate artifacts) are then correlated for each process activity (Step 1104), for example, by transaction ID, agent input, references to digital documents related to the transactions, and the like). The correlated information is then stored into a data store (Step 1106).

FIG. 12 is an illustration of a flowchart that depicts a process for inferring events to derive delimiters of system interactions in accordance with an illustrative embodiment. The process is generally designated by reference number 1200, and may be implemented as Step 538 in FIG. 5. The process begins by deriving markers as start/end/suspension/resumption of a system/application (Step 1202). This may be done by detecting markers signaling the start/end/suspension/resumption of the system/application. Possible types of markers include application specific events (for example, app page display, page switch, url activate, switch close, http request/response). Details (including input/output/intermediate artifacts) for each system/application (for example, agent information, keyboard/mouse input, references to digital documents) are then correlated (Step 1204), and the correlated information is then stored into a data store (Step 1206).

FIG. 13 is an illustration of a flowchart that depicts a process for computing metrics and KPIs relating to agent/system/transaction/process behaviors in accordance with an illustrative embodiment. The process is generally designated by reference number 1300, and may be implemented as Step 540 in FIG. 5. The process includes computing metrics and KPIs related to agent behavior (Step 1302). This may include computing metrics and KPIs related to the agent's availability, efficiency, utilization, and the like. This may also include computing metrics and KPIs related to the time spent by the agent on an activity, on an application, on an application for an activity, time spent on non-value added activities (e.g., meetings, training, etc.), and related to volume of material submitted for an activity.

Metrics and KPIs may also be computed relating to system behavior (Step 1304). This may include time spent on an application, response time and the like.

Metrics and KPIs relating to transactional behavior may also be computed (Step 1306). This may include computations related to cycle time, transaction level agent behavior, waste and first time resolution rate.

Metrics and KPIs related to process behavior may also be computed (Step 1308). This may include time spent on a process activity or volume of material submitted for a process activity. It may also include cycle time, throughput, defect rate, waste, and the like.

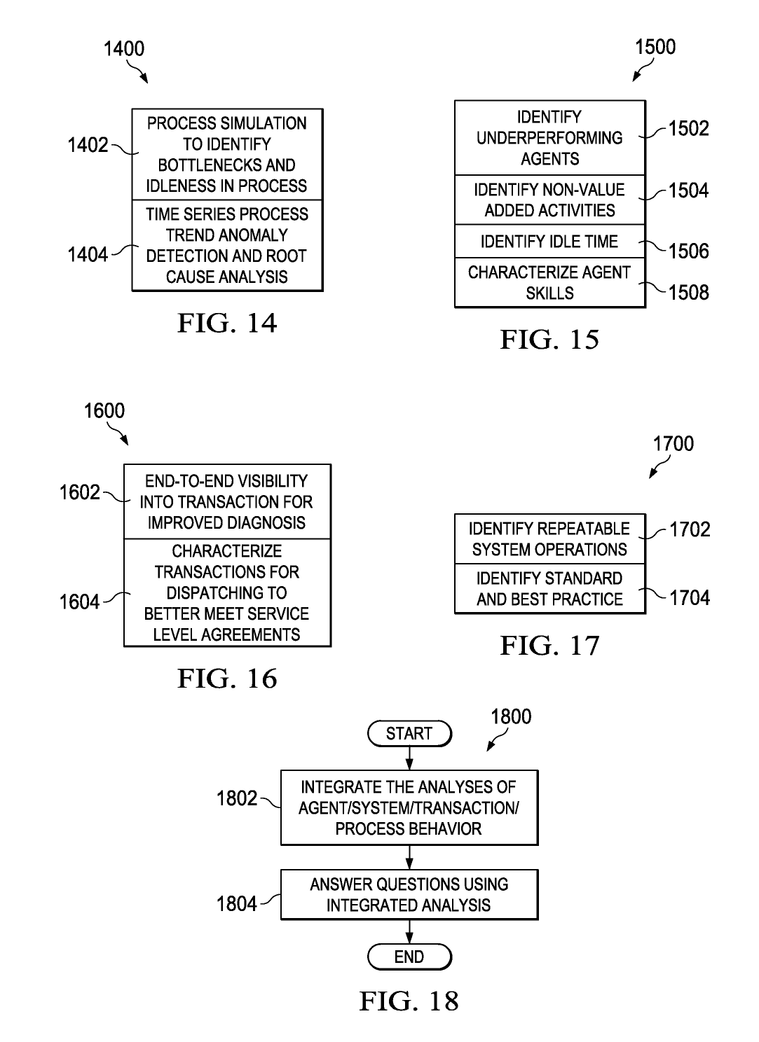

FIG. 14 is an illustration listing types of process behavior analyses that may be performed in accordance with an illustrative embodiment. The listing is generally designated by reference number 1400 and may be performed as part of Step 542 in FIG. 5. The types of process behavior analyses that may be performed include performing a simulation to identify bottlenecks and idleness in the process 1402. Such a simulation may be used to drive optimization in the process. The analyzing may also include time series process trend anomaly detection and root cause analysis 1404. This can be used for process transformation and improvement.

FIG. 15 is an illustration listing types of agent behavior analyses that may be performed in accordance with an illustrative embodiment. The listing is generally designated by reference number 1500, and may be performed as part of Step 544 in FIG. 5. The types of agent behavior analyses that may be performed include identifying underperforming agents 1502. Identifying underperforming agents enables the agents to be targeted for further training and/or retraining. Agent behavior may also be analyzed to identify non-value added activities performed by agents to assist in reducing waste 1504, and to identify idle time to improve agent utilization 1506. Yet further, by analyzing agent behavior, it becomes possible to characterize agent skills based on activities and performance for workforce optimization 1508.

FIG. 16 is an illustration listing types of transaction behavior analyses that may be performed in accordance with an illustrative embodiment. The listing is generally designated by reference number 1600, and may be performed as part of Step 546 in FIG. 5. The types of transaction behavior analyses that may be performed may include providing end-to-end visibility into a transaction for improved diagnosis of the transaction behavior 1602. In addition, analysis of transaction behavior enables characterization of transactions for dispatching to better meet service level agreements 1604.

FIG. 17 is an illustration listing types of system behavior analyses in accordance with an illustrative embodiment. The listing is generally designated by reference number 1700, and may be performed as part of Step 548 in FIG. 5. The types of analyses may include identifying repeatable system operations 1702 and identifying standard and best practices 1704. Identifying repeatable system operations may enable such operations to be automated, while identifying standard and best practices may assist in automatically guiding agent operations.

FIG. 18 is an illustration of a flowchart that depicts a process for integrating agent/system/transaction/process behavior analyses in accordance with an illustrative embodiment. The process is generally designated by reference number 1800, and may be implemented by Step 550 in FIG. 5. The process may include integrating the analyses of agent behavior, system behavior, transaction behavior and process behavior to provide an integrated insight (Step 1802). This may be done by correlating the computed metrics and KPIs from all the behaviors. The integrated analysis may then be used to answer questions which cannot readily be answered by looking at individual behaviors alone (Step 1804). For example, an integrated analysis may provide insight regarding what an agent is doing when the desktop is idle.

Illustrative embodiments thus provide a method for monitoring and analyzing an office process. Information relating to desktop interaction activities of an agent and non-desktop activities of the agent are collected to form collected information. The collected information is inferred to derive delimiters relating to the desktop interaction activities and the non-desktop activities of the agent, at least one transaction performed by the agent, at least one application used by the agent, and the office process. Metrics and key performance indicators relating to a behavior of the agent, a behavior of the at least one transaction, a behavior of the at least one application and a behavior of an office process are computed to form computed information, and the collected information and the computed information are stored into a data store.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for monitoring and analyzing an office process, comprising:
collecting information relating to desktop interaction activities of an agent and non-desktop activities of the agent to form collected information;
inferring the collected information to derive delimiters relating to:
the desktop interaction activities and the non-desktop activities of the agent,
at least one transaction performed by the agent,
at least one application used by the agent, and
an office process;
computing metrics and key performance indicators relating to a behavior of the agent, a behavior of the at least one transaction, a behavior of the at least one application and a behavior of the office process to form computed information; and
storing the collected information and the computed information into a data store.

2. The method of claim 1 further comprising:
providing an analysis of the behavior of each of the agent, the at least one transaction, the at least one application, and the office process.

3. The method of claim 2 further comprising integrating the analysis of the behavior of each of the agent, the at least one transaction, the at least one application, and the office process.

4. The method of claim 1 further comprising:
planning and customizing a monitoring activity for monitoring the desktop interaction activities conducted by the agent, the non-desktop activities conducted by the agent, and the at least one transaction.

5. The method of claim 1, wherein collecting information relating to desktop interaction activities of the agent, comprises collecting information relating to at least one of a windows event, a keyboard event, an application specific event and an artifact related event.

6. The method of claim 1, wherein collecting information relating to non-desktop activities of the agent, comprises collecting information relating to at least one of a workstation event, an event recorded by another device, and an event observed by a human.

7. The method of claim 1, wherein inferring the collected information to derive delimiters relating to the desktop interaction activities and the non-desktop activities of the agent, comprises:
deriving markers signaling a start, end, suspension or resumption of each activity performed by the agent;
correlating details of each activity performed by the agent to form correlated information; and
storing the correlated information.

8. The method of claim 7, wherein inferring the collected information to derive delimiters relating to the at least one application, comprises inferring the collected information to derive details of at least one application used by the agent and belonging to at least one activity of the agent.

9. The method of claim 1, wherein inferring the collected information to derive delimiters relating to the at least one transaction, comprises:
deriving details of activities belonging to the at least one transaction;
correlating the details to form correlated information; and
storing the correlated information.

10. The method of claim 1, wherein inferring the collected information to derive delimiters relating to the at least one application, comprises:
deriving markers signaling a start, end, suspension or resumption of the at least one application;
correlating details for each at least one application to form correlated information; and
storing the correlated information.

11. The method of claim 10, wherein inferring the collected information to derive delimiters relating to at least one application, comprises inferring the collected information to derive details of at least one application used by the agent and belonging to at least one activity of the agent.

12. The method of claim 1, wherein inferring the collected information to derive delimiters relating to the office process, comprises:
deriving details of activities belonging to the office process;
correlating details relating to each activity to form correlated information; and
storing the correlated information.

13. The method of claim 1, wherein the office process comprises a back office process.

14. A computer program product in a computer recordable storage medium for monitoring and analyzing an office process, the computer program product having computer usable program code for:
collecting information relating to desktop interaction activities of an agent and non-desktop activities of the agent to form collected information;
inferring the collected information to derive delimiters relating to:
the desktop interaction activities and the non-desktop activities of the agent,
at least one transaction performed by the agent,
at least one application used by the agent, and
an office process;
computing metrics and key performance indicators relating to a behavior of the agent, a behavior of the at least one transaction, a behavior of the at least one application and a behavior of the office process to form computed information; and
storing the collected information and the computed information into a data store.

15. The computer program product of claim 14 further comprising:
computer usable program code for providing an analysis of the behavior of each of the agent, the at least one transaction, the at least one application, and the office process; and
computer usable program code for integrating the analysis of the behavior of each of the agent, the at least one transaction, the at least one application, and the office process.

16. The computer program product of claim 14 further comprising:
computer usable program code for planning and customizing a monitoring activity for monitoring the desktop interaction activities conducted by the agent, the non-desktop activities conducted by the agent, and the at least one transaction.

17. The computer program product of claim 14, wherein the computer usable program code for collecting information relating to desktop interaction activities of the agent, comprises:
computer usable program code for collecting information relating to at least one of a windows event, a keyboard event, an application specific event and an artifact related event.

18. The computer program product of claim 14, wherein the computer usable program code for collecting information relating to non-desktop activities of the agent, comprises:
computer usable program code for collecting information relating to at least one of a workstation event and an event recorded by another device.

19. The computer program product of claim 14, wherein the computer usable program code for inferring the collected information to derive delimiters relating to the desktop interaction activities and the non-desktop activities of the agent, comprises computer usable program code for:
deriving markers signaling a start, end, suspension or resumption of each activity performed by the agent;
correlating details of each activity performed by the agent to form correlated information; and
storing the correlated information.

20. The computer program product of claim 19, wherein the computer usable program code for inferring the collected information to derive delimiters relating to at least one application, comprises computer usable program code for inferring the collected information to derive details of at least one application used by the agent and belonging to at least one activity of the agent.

21. The computer program product of claim 14, wherein the computer usable program code for inferring the collected information to derive delimiters relating to the at least one transaction, comprises computer usable program code for:
deriving details of activities belonging to the at least one transaction;
correlating the details to form correlated information; and
storing the correlated information.

22. The computer program product of claim 14, wherein the computer usable program code for inferring the collected information to derive delimiters relating to the at least one application, comprises computer usable program code for:
deriving markers signaling a start, end, suspension or resumption of the at least one application;
correlating details for each at least one application to form correlated information; and
storing the correlated information.

23. The computer program product of claim 22, wherein the computer usable program code for inferring the collected information to derive delimiters relating to at least one application, comprises computer usable program code for inferring the collected information to derive details of at least one application used by the agent and belonging to at least one activity of the agent.

24. The computer program product of claim 14, wherein the computer usable program code for inferring the collected information to derive delimiters relating to the office process, comprises computer usable program code for:
deriving details of activities belonging to the office process;
correlating details relating to each activity to form correlated information; and
storing the correlated information.

25. An apparatus, comprising:
a memory storing instructions, and
at least one processing unit for executing the instructions for monitoring and analyzing an office process in a data processing system, the at least one processing unit executing the instructions to:
collect information relating to desktop interaction activities of an agent and non-desktop activities of the agent to form collected information;
infer the collected information to derive delimiters relating to:
the desktop interaction activities and the non-desktop activities of the agent,
at least one transaction performed by the agent,
at least one application used by the agent, and
an office process;
compute metrics and key performance indicators relating to a behavior of the agent, a behavior of the at least one transaction, a behavior of the at least one application and a behavior of the office process to form computed information; and
store the collected information and the computed information into a data store.
